(19) United States
(12) Patent Application Publication
(10) Pub. No.: US 2006/0257296 A1
(43) Pub. Date: Nov. 16, 2006

(54) Alkali metal dispensers and uses for same

(75) Inventor: Steven A. Lipp, West Windsor, NJ (US)

Correspondence Address: LOWENSTEIN SANDLER P.C., 65 LIVINGSTON AVENUE, ROSELAND, NJ, 07068, US

(73) Assignee: Sarnoff Corporation, Princeton, NJ (US)

(21) Appl. No.: 11/435,199

(22) Filed: May 15, 2006

Related U.S. Application Data
(60) Provisional application No. 60/681,117, filed on May 13, 2005.

(51) Int. Cl. B32B 27/04; G21C 1/00

(52) U.S. Cl. 422/159

(57) ABSTRACT

The present invention provides alkali metal dispenser compositions, systems for generating free, unbound alkali metal atoms that contain the compositions of the present invention, and processes for using such systems.

### CROSS-REFERENCE TO RELATED APPLICATION

This application claims priority benefit of U.S. Provisional Application Ser. No. 60/681,117 filed May 13, 2005, which is hereby incorporated by reference in its entirety.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. W911NF-04-I-0043 awarded by the Defense Advanced Research Projects Agency (DARPA) of the U.S. Department of Defense (DoD).

### FIELD OF INVENTION

The present invention relates to an alkali metal dispenser composition and a system comprising the composition, which can be used to generate free, unbound alkali metal atoms.

### BACKGROUND OF THE INVENTION

Alkali metals are useful in various scientific areas and techniques such as, atomic physics (the study of the structure and characteristics of atoms), molecular physics (the study of the structure and characteristics of molecules), laser cooling (the use of a laser to slow down atoms or molecules by adjusting the frequency of the laser (photons) so as to remove momentum from atoms or molecules, thereby causing the atoms or molecules to be less energetic), magneto-optical trap (MOT) (a device that cools down atoms to temperatures near absolute zero (0° K) and traps them at a certain place using magnetic fields and circularly polarized laser light) and Bose-Einstein condensate (BEC) (a phase of matter formed by bosons (particles with integer spin) cooled to temperatures near to absolute zero.

Further alkali metals are useful in a number of applications, many on an atomic- and nano-scale (e.g., about 0.1 nm to about 100 nm), for example, and without limitation, atomic clocks (clocks that use an atomic resonance frequency standard as their counter), atom interferometers (instruments based on exploiting the wave character of atoms to make precise measurements, such as of distance), atom gyroscopes (a type of atom interferometer that provides precise measurements of rotation and acceleration), atom lasers (a coherent state, which is a specific quantum state, of propagating atoms) and quantum computing (the use of quantum properties of particles to represent and structure data with quantum mechanisms devised and built to perform operations with the data).

Sources of alkali metals (i.e., alkali metal atoms) often are (1) the pure alkali metals themselves, which are very reactive in air (e.g., igniting spontaneously in air and thus, are not present in nature in elemental form), or (2) metal dispensers, which often are compositions containing the chromate derivatives of the alkali metals mixed with a metal powder getter. At elevated temperatures, such as, about 500° C. to about 700° C., the alkali metal chromate of such compositions decomposes and the alkali metal atom is emitted along with some gases. The metal powder getter of the alkali metal chromate composition is intended to remove the gases from an environment containing the alkali metal atoms and emitted gases, but hydrogen gas often is a problem. Hydrogen gas is difficult to remove from the environment with the metal powder getter, or by pump, and particularly, is deleterious in many uses of alkali metal vapors.

Thus, there is a need for an alkali metal dispenser composition that minimally produces gases that are difficult to remove from an environment via pump or getter when the alkali metal atom is generated from it; such gases, include, without limitation, hydrogen gas and low volatility materials. Also keenly needed is an alkali metal dispenser composition that is isotopically enriched in a particular alkali metal atom, such as rubidium-87 (Rb-87). Such alkali metal dispenser compositions then could be used to provide for the efficient and effective generation of alkali metal atoms (meaning, e.g., for less costs (labor and expense) and at lower temperatures). The present invention is directed to these and other unmet needs.

### SUMMARY OF THE INVENTION

The present invention provides an alkali metal dispenser composition that comprises an alkali metal source, a getter for alkali metals and optionally, a reducing agent, where the reducing agent is not an alkaline earth metal.

The present invention also provides an alkali metal dispenser composition produced by a process, the process comprising:
a. mixing an alkali metal source with a getter for alkali metals to form a first mixture;
b. optionally, adding a reducing agent to the first mixture to form a second mixture, where the reducing agent is not an alkaline earth metal; and
c. heating the first mixture, or if (b) is performed, the second mixture, thereby producing an alloy that comprises the alkali metal atoms from the alkali metal source and metallic atoms from the getter.

Also provided by the present invention is a system for generating alkali metal atoms, the system comprising:
a. an alkali metal dispenser composition according to the present invention; and
b. a heating element; and
c. optionally, a pump,
   wherein the heating element is positioned so as to deliver heat to the alkali metal dispenser composition.

The present invention also provides a process for generating free, unbound alkali metal atoms, the process comprising:
a. selecting a system for generating alkali metal atoms according to present invention;
b. heating the alkali metal dispenser composition of the sytem by way of the heating element of the system;
c. dissociating bound alkali metal atoms from the alloy of the alkali metal dispenser composition thereby, generating free, unbound alkali metal atoms;
d. maintaining the process under a controlled environment; and
e. optionally, removing contaminants from the system.

### DETAILED DESCRIPTION OF THE INVENTION

Definitions. In describing the present invention, the following terms and phrases will be used with the intent to be defined as indicated immediately below. Definitions for other terms and phrases can occur throughout the specification. It is intended that all terms and phrases used in the specification include the plural, active tense and past tense forms of a term or a phrase.

As used herein, the phrase “alkali metal” refers to an element in Group 1 (International Union of Pure and Applied Chemistry (IUPAC)) of the periodic table of the chemical elements, and includes, e.g., cesium (Cs), francium (Fr), lithium (Li), potassium (K), rubidium Rb) and sodium (Na).

The phrase, “alkaline earth metal,” as used herein, refers to an element of Group 2 (IUPAC) of the periodic table of the chemical elements, and includes, e.g., barium (Ba), beryllium (Be), calcium (Ca), magnesium (Mg) and strontium (Sr).

The term “alloy,” as used herein, refers to a mixture of two or more metals or of one or more metals with certain metalloids (meaning nonmetallic elements, such as arsenic and selenium, with some of the chemical properties of metals) that are mutually soluble in the molten condition; distinguished as binary, ternary, quaternary, etc., depending on the number of metals in the mixture.

The phrase “controlled environment,” as used herein, refers to an area whose atmosphere is maintained under a vacuum (defined herein) or so as to be inert (defined herein).

The phrase “getter for alkali metals” refers to a substance that lowers the amount of the free, unbound alkali metal atoms available, e.g., by binding or interacting with the alkali metal atoms. Often a getter for alkali metals is a “metal,” i.e., a substance having overlapping conductance bands and valence bands in its electronic structure.

As used herein, the term “heating” and the phrase “heating element” refer to a means for providing heat; and includes, without limitation, (1) “resistive heating” meaning a process whereby the temperature of a material increases due to its ability to convert electricity into heat as a result of resistance to the electrical current flowing through it; such a material is often referred to as a “conductor” (meaning a material that contains movable charges of electricity); (2) “induction heating,” which refers to a process that relies on induced electrical currents within a material to raise the temperature of the material and thus, produce heat. Induction heating uses an alternating current (AC) power supply, induction coil and a material to be heated (often referred to as a “workpiece”). When the workpiece is placed in the coil, the AC power supply sends alternating current through the coil, thereby, generating an electromagnetic field, which induces eddy currents in the workpiece, thus, raising the temperature of the workpiece by subjecting it to the alternating electromagnetic field without any physical contact between the coil and the workpiece. And includes (3) “lasers” (Light Amplification by Stimulated Emission of Radiation) meaning sources of light that can be concentrated to produce a small spot of intense heat energy.

The phrase “isotopically-enriched,” as used herein, means having, or being of, at least about 95% of one isotope of an atom.

The term, “nichrome,” as used herein, refers to a non-magnetic alloy of nickel and chromium, which has a high electrical resistance and an ability to withstand high temperatures.

The term, “inert,” as used herein, means having a limited ability, or lacking the ability, to react chemically.

As used herein, the term “mixture” refers to a sample of matter having more than one pure element or compound in association where the elements or compounds retain their properties within the sample. A mixture can be homogeneous (meaning uniform or identical throughout) or heterogeneous (meaning dissimilar or non-uniform throughout).

As used herein, the term “redox” refers to a reduction-oxidation reaction whereby one compound is “reduced” (meaning it loses an oxygen atom while gaining electrons; or its oxidation number (oxidation state) decreases), while another compound is “oxidized” (meaning it acquires an oxygen atom while losing electrons; or its oxidation number (oxidation state) increases). As used herein, the phrase “oxidation number” or “oxidation state” refers to the number of electrons that must be added to or subtracted from an atom in a combined state to convert it to the elemental form, i.e., the form relating to, being or existing as an uncombined chemical element.

As used herein, the phrase “reducing agent” refers to a substance that is oxidized (see “redox” defined herein) and causes another substance to be reduced (see “redox” defined herein).

The term, “vacuum,” as used herein, means under pressure below atmospheric pressure.

In one aspect, the present invention provides an alkali metal dispenser composition comprising:
a. an alkali metal source;
b. a getter for alkali metals; and
c. optionally, a reducing agent, wherein the reducing agent is not an alkaline earth metal.

In another aspect, the present invention provides an alkali metal dispenser composition produced by a process comprising:
a. mixing an alkali metal source with a getter for alkali metals to form a first mixture;
b. optionally, adding a reducing agent to the first mixture to form a second mixture, wherein the reducing agent is not an alkaline earth metal; and
c. heating the first mixture, or if (b) is performed, the second mixture, thereby producing an alloy that comprises the alkali metal atoms from the alkali metal source and metallic atoms from the getter.

In some embodiments of the alkali metal dispenser composition of the present invention, the alkali metal source comprises an alkali metal, a carbonate derivative of an alkali metal or a halogen derivative of an alkali metal. In some embodiments, the alkali metal source is an alkali metal, for example, lithium, sodium, potassium, rubidium, or cesium.

In some embodiments, the alkali metal source of the alkali metal dispenser composition of the present invention is a carbonate derivative of an alkali metal. In some embodiments, the carbonate derivative of an alkali metal is lithium carbonate, sodium carbonate, potassium carbonate, rubidium carbonate, or cesium carbonate. In some embodiments, the carbonate derivative of an alkali metal is rubidium carbonate (Rb₂CO₃). In some embodiments of the alkali metal dispenser of the present invention, the rubidium carbonate comprises the rubidium isotope, rubidium-87 (Rb-87). In some embodiments, the amount of Rb-87 in the rubidium carbonate is about 25%, about 26%, about 27%, about 28%, about 29% or about 30% on a weight/weight percent (% w/w) basis. In some embodiments, the amount of Rb-87 in the rubidium carbonate is about 95%, about 96%, about 97%, about 98%, about 99% or about 100% on a % w/w basis.

In some embodiments, the alkali metal source of the alkali metal dispenser composition of present invention is a halogen derivative, such as, lithium fluoride, lithium chloride, lithium bromide, lithium iodide, sodium fluoride, sodium chloride, sodium bromide, sodium iodide, potassium fluoride, potassium chloride, potassium bromide, potassium iodide, rubidium fluoride, rubidium chloride, rubidium bromide, rubidium iodide, cesium fluoride, cesium chloride, cesium bromide or cesium iodide.

In some embodiments of the alkali metal dispenser composition of the present invention, the getter for alkali metals comprises gold, silver or copper.

In some embodiments, the optional reducing agent is absent from the alkali metal dispenser composition of the present invention. In some embodiments, the optional reducing agent is absent from the process by which the alkali metal dispenser composition of the present invention is produced. In some embodiments, the optional reducing agent is present in the alkali metal dispenser composition of the present invention. In some embodiments, the optional reducing agent is present in the process by which the alkali metal dispenser composition of the present invention is produced. In some embodiments, the reducing agent comprises carbon. Without being bound by any particular theory, when a reducing agent is present with an alkali metal source that is not an alkali metal itself, a reduction-oxidation (redox) reaction can occur whereby the reducing agent provides for a more efficient disassociation (e.g., less time) of the alkali metal atoms from its source than when a reducing agent is absent from the alkaline dispenser compositon. As a result, the unbound alkali metal atoms can form more efficiently an alloy with the metallic atoms of the getter of the alkaline dispenser composition of the present invention. For example, and without limitation, if rubidium carbonate is the alkali metal source of an alkali metal dispenser composition of the present invention, which also contains a reducing agent, such as carbon, the following redox reaction (I) could occur by which rubidium atoms would be provided, the rubidium atoms then could form an alloy with the metallic atoms of the getter previously discussed. This reaction initiates below the melting point of rubidium carbonate, which has been reported to be 837° C., and proceeds at temperatures of about 560° C. to about 700° C.

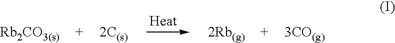

In some embodiments, the alkali metal dispenser composition of the present invention, further comprises an alloy, where the alloy comprises alkali metal atoms from the alkali metal source and metallic atoms from the getter. In some embodiments, the alkali metal atoms of the alloy comprise lithium, sodium, potassium, rubidium or cesium and the metallic atoms of the alloy comprise gold. In some embodiments, the alkali metal atoms of the alloy are rubidium and the metallic atoms of the alloy are gold. In some embodiments, the alloy comprises RbAu, RbAu₂ or RbAu₄. In some embodiments, the rubidium comprises rubidium-87 isotope. In some embodiments, the rubidium-87 isotope comprises about 95% w/w to about 100% w/w of the rubidium of the alloy.

In some embodiments, the alkali metal atoms of the alloy of the alkali metal dispenser composition of the present invention are lithium or sodium and the metallic atoms of the alloy are silver. In some embodiments, the alkali metal atoms of the alloy are lithium and the metallic atoms of the alloy are copper.

In some embodiments of an alkali metal composition produced by a process of the present invention, the heating of a first mixture or a second mixture, as described herein, comprises using resistive heating, induction heating, or lasers. In some embodiments, the heating is resistive heating, such that, for example, and without limitation, the material to be heated (i.e., the conductor) is nichrome or tungsten. In some embodiments, the heating is induction heating. In some such embodiments, the induction coil used in induction heating is in close proximity (i.e., physically nearby but without contact) to the alkali metal dispenser composition of the present invention. The heating of the first or second mixture of the present invention allows for the formation of an alloy, as described previously. Further, when the mixture comprises an alkali metal source, a getter for alkali metals and a reducing agent (i.e., a second mixture, as described above), the heating provides for the dissociation of the alkali metal atoms from the alkali metal source, and to which the reducing agent enhances the dissociation therefrom, as previously described. (See also, reaction (I), hereinabove).

In some embodiments, an alkali metal dispenser composition of the present invention comprises:
a. an alkali metal source that comprises rubidium;
b. a getter for alkali metals that comprises gold;
c. a reducing agent that comprises carbon; and
d. an alloy, wherein the alloy comprises rubidium atoms from the alkali metal source (a) and gold atoms from the getter (b).

In some embodiments of the present invention, an alkali metal dispenser composition is produced by a process comprising:
a. mixing an alkali metal source that comprises rubidium with a getter for alkali metals that comprises gold to form a first mixture;
b. optionally, adding a reducing agent that comprises carbon to the first mixture to form a second mixture; and
c. heating the first mixture, or if (b) is performed, the second mixture, thereby producing an alloy that comprises rubidium and gold.

In some embodiments of an alkaline dispenser composition produced by a process of the present invention, the rubidium of the alkali metal source comprises rubidium-87 isotope, and the rubidium-87 isotope comprises about 95% w/w to about 100% w/w of the rubidium of the alkali metal source.

In another aspect, the present invention provides a system for generating alkali metal atoms (i.e., free, unbound alkali metal atoms) that comprises:
a. an alkali metal dispenser composition of the present invention, as described herein;
b. a heating element; and
c. optionally, a pump,
   wherein the heating element is positioned so as to deliver heat to the alkali metal dispenser composition. The heating element of the system effects the release of free, unbound alkali metal atoms from the dispenser composition. Without being bound by any particular theory, the metallic atoms of the getter provide the ability to control the release of free, unbound alkali metal atoms from the alloy of the dispenser composition of the present invention. Further, the controlled release of free, unbound alkali metal atoms can be accomplished with the heating element of the system, where the ability to control the release is enhanced by the type of heating element used and how it is employed.

In some embodiments, the system for generating alkali metal atoms of the present invention further comprises a chamber, wherein the chamber houses at least the alkali metal dispenser composition. As used herein, the term “chamber” refers to a means for providing a controlled environment under which the alkali metal dispenser composition of the present invention can be maintained, as well as the free, unbound alkali metal atoms generated from the composition; and includes, for example, and without limitation, a cell (such as, a glass cylinder of about 6 inches to about 8 inches long with a diameter of about 1 to about 2 inches), a cuvette (a glass, quartz or plastic chamber with e.g., a nominally rectangular or square cross-section of about 10 mm to about 30 mm and a height of about 30 to about 80 mm) and the like.

In some such embodiments, the chamber of the system of the present invention houses the heating element. In some embodiments, the heating element is outside of (i.e., external to) the chamber. In some embodiments, the heating element of the system of the present invention operates through resistive heating, induction heating or laser energy (i.e., the energy provided by a laser). In some embodiments, the heating element comprises a material resistive to heating (e.g., a conductor), a workpiece (i.e., a material that can be heated by induction), or a laser. In some embodiments, the system of the present invention comprises a pump. The pump can be used, for example, and without limitation, to maintain a controlled environment or to remove contaminants, including undesirable gases, such as hydrogen, and low volatility materials, from the chamber of the system.

In some embodiments of the system of the present invention, the alloy of the alkali metal dispenser composition comprises rubidium and gold.

In a further aspect, the present invention provides a process for generating free, unbound alkali metal atoms, the process comprising:
a. selecting a system for generating alkali metal atoms of the present invention, as described herein;
b. heating the alkali metal dispenser composition of the sytem by way of the heating element of the system;
c. dissociating bound alkali metal atoms from the alloy of the alkali metal dispenser composition thereby, generating free, unbound alkali metal atoms;
d. maintaining the process under a controlled environment; and
e. optionally, removing contaminants (such as, undesirable gases produced during the process and low volatility materials present before and during the process) from the system.

In some embodiments of the process of the present invention for generating free, unbound alkali metal atoms, the alloy comprises rubidium and gold.

In some embodiments of the process of the present invention for generating free, unbound alkali metal atoms, the free, unbound alkali metal atoms generated are rubidium. In some embodiments, the free, unbound alkali metal atoms generated are isotope rubidium-87. In some embodiments, the isotope rubidium-87 generated are about 95% to about 100% of the rubidium atoms generated by the process for generating free, unbound alkali metal atoms of the present invention.

Unless defined otherwise, all technical and scientific terms used herein have the same meaning as commonly understood by one of ordinary skill in the art to which this invention belongs. The present invention encompasses any processes and materials similar or equivalent to those described herein and it is not limited to those processes and materials described herein. All publications mentioned herein are incorporated herein by reference to disclose and described the methods and/or materials in connection with which the publications are cited.

It must be noted that, as used herein and in the appended claims, the singular forms “a”, “and”, and “the” include plural references, unless the context clearly dictates otherwise. All technical and scientific terms used herein have the same meaning when used.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates, which may need to be confirmed independently.

### EXAMPLES

The following examples are put forth so as to provide those of ordinary skill in the art with a complete disclosure and description of how to make and use the present invention, and are not intended to limit the scope of what the inventor regards as his invention nor are they intended to represent that the experiments below are all or the only experiments performed. Efforts have been made to ensure accuracy with respect to numbers used (e.g., amounts, temperature, etc.), but an account for some experimental errors and deviations should be made. Unless indicated otherwise, parts are parts by weight, molecular weight is average molecular weight, and temperature is in degrees Centigrade.

The rubidium, gold and carbon used in the following Examples are available from many sources including, e.g., Reade Advanced Materials (East Providence, R.I.) and Electronic Space Products International (ESPI) (Ashland, Oreg.).

### Example 1

### Preparation and Testing of Representative Rubidium Dispenser Compositions

A new source of rubidium (Rb) was designed around alloys of gold with rubidium. The rubidium sources used in all parts of Example 1 comprised about 70% to about 75% Rb-85 and about 25% to about 30% Rb-87 (i.e., the rubidium sources comprised approximately the percent natural abundances of each rubidium isotope).

Rubidium Dispenser Composition A

When warm liquid Rb (e.g., about 1 mg to about 10 mg) was mixed with gold (Au) powder (e.g., about 80 mg to about 120 mg), a paste was formed which solidified at room temperature. The resultant material (i.e., an alloy comprising Rb alkali metal atoms and metallic atoms of gold) when heated (e.g., with a nichrome ribbon at about 300° C. to about 600° C.) in a vacuum emitted a Rb vapor (i.e., free, unbound Rb atoms dispersed within a gaseous medium). The presence of the Rb vapor was confirmed by the absorption of a 780 nm laser emission on a calibrated silicon (Si) photodiode.

Rubidium Dispenser Composition B

A Rb dispenser composition was prepared as described for Rb dispenser composition A of Example 1, except that about 4 mg to about 8 mg rubidium carbonate was used. The composition was heated in a vacuum and a similar emission to that of composition A of Example 1 was observed.

Rubidium Dispenser Composition C

In order to make these materials (i.e., the alkali metal dispenser compositions) handleable, the starting materials were fabricated as pellets using a homemade pelletizer, comprising a plastic rod (low density polyethylene (LDPE)) having a length of one-half (½) inch and a diameter of one-half (½) inch. A hole (one-sixteenth ( 1/16) inch in diameter and one-quarter (¼) inch in depth) was drilled in the plastic rod. The alkali metal dispenser composition to be pelletized was placed in the hole of the plastic rod, and then the LDPE rod, containing the sample to be palletized, was placed in a stainless steel block having a one-half (½) inch hole drilled into it to accommodate the LDPE rod. A one-half (½) inch stainless steel rod was placed on top of the plastic rod containing the sample to be palletized (i.e., sample of the dispenser composition of the invention). The whole block, with the plastic rod, sample and stainless steel rod, was inserted between the plates of a hydraulic the press.

Gold powder (e.g., about 80 mg to about 120 mg) was mixed with liquid Rb and pressed at about 10,000 psi (pounds per square inch) to about 15,000 psi into a pellet, as described above. The pellet, thus, comprised an alloy containing alkali metal atoms of Rb and metallic atoms of gold. Although it was very difficult to determine the exact amount of Rb metal, which had to be handled in a glove box until it was thoroughly mixed with the gold, the amount of Rb used was, for example, about 5 mg to about 10 mg. When the gold/Rb pellet was placed on a nichrome ribbon and heated to over about 600° C., a fluorescence above the gold/Rb pellet when excited with a 780 nm laser beam was observed. This is indicative of the presence of Rb atoms in the chamber. The intensity of the fluorescence was proportional to the temperature.

Using a SGA 200 Residual Gas Analyzer (RGA), the generation of the carbon dioxide, carbon monoxide and water was followed as the sample was heated. After heating for about 3 hours, the amount of these gases approached the background gas evolution of the system. The gold/Rb pellet was handled (i.e., made and then loaded into the nichrome ribbon) in air and probably absorbed considerable carbon dioxide, oxygen and water before it was placed in the vacuum chamber because, if the metallic Rb was kept in a vacuum or a water, oxygen and carbon dioxide-free-environment, Rb would not have been able to react with these substances, and the subsequent evolution of their gases would not be expected.

Rubidium Dispenser Composition D

A Rb dispenser composition was prepared as described for Rb dispenser composition C of Example 1, except that about 4 mg rubidium carbonate (w/w %) was used. The gold/rubidium carbonate mixture was more stable than the gold/liquid Rb mixture of composition C, and likely only absorbed water when exposed to the room air.

### Example 2

### Preparation and Testing of a Representative Isotopically-Enriched Rubidium-87 Dispenser Composition

The commercial availability of isotopically-enriched Rb-87 presently is limited to the carbonate and the chloride derivatives. Since getting pure Rb-87 is an ultimate goal for alkali metal sources such as the dispenser compositions of the present invention, the carbonate derivative of Rb-87 was used to make other Rb/gold pellets. A mixture of about 4% rubidium carbonate (w/w %) in gold powder was pressed into an about one-sixteenth ( 1/16) inch wide pellet. Because the Rb-87 carbonate is hydroscopic, it was dried in an oven before being pelletized. After pressing, the pellet was stored in nitrogen (meaning gaseous molecular nitrogen, N₂).

At the time of testing, the pellet was wedged into a fold in a nichrome ribbon and pumped down (i.e., the nichrome ribbon containing the pellet was placed in a vacuum chamber and the chamber evacuated). The Rb-87 carbonate had to be decomposed thermally in a vacuum to form the Rb metal (i.e., to dissociate the Rb atom from it's carbonate derivative), which could in turn react with the gold to form an alloy of Rb/gold. Thus, the nichrome ribbon and pellet were heated with about 4 amps of power to start the processing (i.e., to condition the rubidium carbonate so as to make available the rubidium atoms therein, which could then react with gold atoms to form the alloy). The absorption of the 780 nm laser, by the silicon photo-diode, was exceptionally strong, but so was the residual gas evolution. That is to say, the absorption of the 780 nm laser signal of the cell (in which the pellet was being tested) while being pumped, was as high as that observed with a sealed cell of pure Rb in equilibrium with solid rubidium at room temperature, but the carbon monoxide (CO) and carbon dioxide (CO₂) residual gas evolution also was present. By cycling the pellet with about 10 minutes on (i.e., with power being delivered) at successively higher currents and then dropping the current, as shown below, it was observed that the CO and CO₂ gas evolution was lowering and the Rb absorption of the 780 nm laser still remained detectable, although somewhat diminished (i.e., the absorption of the 780 nm laser was slightly lower than when observed at a lower current).

The cycling, at about 560° C., went as shown in the Table below.

| Time (minutes) | Power (amps) |
|---|---|
| about 10 | about 4.0 |
| about 10 | about 4.2 |
| about 10 | about 4.0 |
| about 10 | about 4.4 |
| about 10 | about 4.0 |
| about 10 | about 4.6 |
| about 10 | about 4.0 |
| about 10 | about 4.8 |
| about 10 | about 4.0 |
| about 10 | about 5.0 |
| about 10 | about 4.0 |
| about 10 | about 5.2 |
| about 10 | about 4.0 |
| about 10 | about 5.4 |
| about 10 | about 4.0 |
| about 10 | about 5.6 |
| about 10 | about 4.0 |

Each time the power was brought back to about 4.0 amps, the base pressure improved and the Residual Gas Analyzer (RGA) results showed less carbon dioxide evolution. The water background in the system always was high enough that a change in this peak could not be observed.

The pellet then was pumped down over the weekend and then the residual gas measured via the RGA at room temperature and about 4.0 amps. There was only a slight change in the RGA results at about 4.0 amps and the Rb fluorescence was visible constantly after about 8 hours of heating.

These results mean that the generation of isotopically-enriched Rb-87 can be accomplished without the use of a reactive metal, such as barium or calcium, which often is accomplished with, for example, RbCl to produce Rb_{(g)} and BaCl or CaCl, respectively, after heating.

### Prophetic Example 3

### Preparation of a Representative Rubidium Dispenser Composition

A Rb dispenser composition can be prepared as described in the previous Examples that use rubidium carbonate as the rubidium source, except that carbon powder can be added to the rubidium carbonate and gold mixture in a mole ratio of about 1:2 (rubidium carbonate to carbon). It is expected that the carbon will enhance the dissociation of the rubidium atom from its rubidium carbonate derivative, thereby, producing the rubidium/gold more efficiently and effectively than when carbon is absent from the composition.

### Prophetic Example 4

### Preparation of a Representative Alkali Metal Dispenser Compositions

Other alkali metal dispenser compositions can be prepared as described in any of the preceding Examples, except that the alkali metal source could be one that comprises, e.g., cesium, potassium, sodium or lithium. A getter for these alkali metals can comprise gold, as described in the preceding Examples. Also, some such alkali metal dispenser compositions further can comprise a non-alkaline earth metal reducing agent, such as, carbon.

Further additional alkali metal dispensers can be prepared as described in any of the preceding Examples, except that if the getter for the alkali metals comprises silver or other inert metal, then a lower atomic weight alkali metal source should be used (e.g., lithium or sodium); but if the getter for the alkali metals comprises copper, then lithium should be used.

While the present invention has been described with respect to what are some embodiments of the invention, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An alkali metal dispenser composition comprising:
a. an alkali metal source;
b. a getter for alkali metals; and
c. optionally, a reducing agent, wherein the reducing agent is not an alkaline earth metal.

2. The alkali metal dispenser composition of claim 1, wherein the alkali metal source comprises an alkali metal, a carbonate derivative of an alkali metal or a halogen derivative of an alkali metal.

3. The alkali metal dispenser composition of claim 2, wherein the carbonate derivative of an alkali metal is rubidium carbonate.

4. The alkali metal dispenser composition of claim 2, wherein the getter for alkali metals comprises gold, silver or copper.

5. The alkali metal dispenser composition of claim 4, further comprising an alloy, wherein the alloy comprises alkali metal atoms from the alkali metal source and metallic atoms from the getter.

6. The alkali metal dispenser composition of claim 5, wherein the alkali metal atoms comprise lithium, sodium, potassium, rubidium or cesium and the metallic atoms comprise gold.

7. The alkali metal dispenser composition of claim 6, wherein the alkali metal atoms are rubidium.

8. The alkali metal dispenser composition of claim 7, wherein the rubidium comprises rubidium-87 isotope, which comprises about 95% w/w to about 100% w/w of the rubidium.

9. An alkali metal dispenser composition produced by a process comprising:
a. mixing an alkali metal source with a getter for alkali metals to form a first mixture;
b. optionally, adding a reducing agent to the first mixture to form a second mixture, wherein the reducing agent is not an alkaline earth metal; and
c. heating the first mixture, or if (b) is performed, the second mixture, thereby producing an alloy that comprises the alkali metal atoms from the alkali metal source and metallic atoms from the getter.

10. The alkali metal dispenser composition of claim 9, wherein the alkali metal source comprises an alkali metal, a carbonate derivative of an alkali metal or a halogen derivative of an alkali metal.

11. The alkali metal dispenser composition of claim 10, wherein the alkali metal is lithium, sodium, potassium, rubidium, or cesium.

12. The alkali metal dispenser composition of claim 10, wherein the carbonate derivative of an alkali metal is lithium carbonate, sodium carbonate, potassium carbonate, rubidium carbonate, or cesium carbonate.

13. The alkali metal dispenser composition of claim 12, wherein the carbonate derivative of an alkali metal is rubidium carbonate.

14. The alkali metal dispenser composition of claim 13, wherein the rubidium carbonate comprises rubidium-87 isotope.

15. The alkali metal dispenser composition of claim 10, wherein the halogen derivative of an alkali metal is lithium fluoride, lithium chloride, lithium bromide, lithium iodide, sodium fluoride, sodium chloride, sodium bromide, sodium iodide, potassium fluoride, potassium chloride, potassium bromide, potassium iodide, rubidium fluoride, rubidium chloride, rubidium bromide, rubidium iodide, cesium fluoride, cesium chloride, cesium bromide or cesium iodide.

16. The alkali metal dispenser composition of claim 10, wherein the getter for alkali metals comprises gold, silver or copper.

17. The alkali metal dispenser composition of claim 16, wherein the reducing agent comprises carbon.

18. The alkali metal dispenser composition of claim 17, wherein the alkali metal atoms comprise lithium, sodium, potassium, rubidium or cesium and the metallic atoms comprise gold.

19. The alkali metal dispenser composition of claim 18, wherein the alkali metal atoms are rubidium and the metallic atoms are gold.

20. The alkali metal dispenser composition of claim 19, wherein the rubidium comprises rubidium-87 isotope.

21. The alkali metal dispenser composition of claim 20, wherein the rubidium-87 isotope comprises about 95% w/w to about 100% w/w of the rubidium of the alloy.

22. The alkali metal dispenser composition of claim 16, wherein the alkali metal atoms are lithium or sodium and the metallic atoms are silver.

23. The alkali metal dispenser composition of claim 16, wherein the alkali metal atoms are lithium and the metallic atoms are copper.

24. A system for generating alkali metal atoms comprising:
a. an alkali metal dispenser composition according to claim 9; and
b. a heating element; and
c. optionally, a pump,
wherein the heating element is positioned so as to deliver heat to the alkali metal dispenser composition.

25. The system of claim 24, further comprising a chamber, wherein the chamber houses at least the alkali metal dispenser composition.

26. The system of claim 25, wherein the chamber further houses the heating element.

27. The system of claim 26, wherein the heating element operates through resistive heating, inductive heating, or laser energy.

28. A process for generating free, unbound alkali metal atoms comprising:
a. selecting a system for generating alkali metal atoms according to claim 24;
b. heating the alkali metal dispenser composition of the sytem by way of the heating element of the system;
c. dissociating bound alkali metal atoms from the alloy of the alkali metal dispenser composition thereby, generating free, unbound alkali metal atoms;
d. maintaining the process under a controlled environment; and
e. optionally, removing contaminants from the system.

29. The process of claim 28, wherein the alloy comprises rubidium and gold.

30. The process of claim 29, wherein the free, unbound alkali metal atoms generated are rubidium.
